(19) United States
(12) Patent Application Publication
(10) Pub. No.: US 2026/0310049 A1
(43) Pub. Date: Oct. 8, 2026

(54) PICTURE RECORDING ARRANGEMENT AND ILLUMINATION ADAPTING METHOD

(71) Applicant: ams-OSRAM AG, Premstaetten (AT)

(72) Inventor: Raoul MALLART, Paris (FR)

(21) Appl. No.: 19/478,843

(22) PCT Filed: Apr. 11, 2024
(86) PCT No.: PCT/EP2024/059820

§ 371 Date: Oct. 27, 2025

(30) Foreign Application Priority Data
May 10, 2023 (DE) 10 2023 112 280.0

(51) Int. Cl. G03B 15/06; G01S 7/481; G01S 17/86; G03B 15/05; G03B 30/00; H04N 23/56

(52) U.S. Cl. CPC G03B 15/06; G01S 7/4815; G01S 17/86; G03B 15/05; G03B 30/00; H04N 23/56

(57) ABSTRACT

Disclosed herein is a picture recording arrangement that enables easy and reliable use. The picture recording arrangement includes an image-taking device having an image-taking field of view. The picture recording arrangement also includes a light source having a plurality of light-emitting units configured to emit light along a plurality of emission directions, the emission directions point outside the image-taking field of view. The picture recording arrangement also includes a depth sensor having a plurality of depth sensor units configured to determine at least one distance along a plurality of sensor directions between the picture recording arrangement and at least one reflective surface, the sensor directions pointing outside the image-taking field of view.

### CROSS-REFERENCE TO RELATED APPLICATION

This application is a national phase of International Patent Application No. PCT/EP2024/059820 filed on Apr. 11, 2024, which claims priority to DE Patent Application No. 102023112280.0 dated May 10, 2023, the contents of each of which are incorporated fully herein by reference.

A picture recording arrangement is provided. A method for adapting illumination using such a picture recording arrangement is also provided.

Document WO 2022/212607 A1 refers to a self-mixing interferometer.

A problem to be solved is to provide a picture recording arrangement that enables easy and reliable use.

This object is achieved, inter alia, by a picture recording arrangement and by a method as defined in the independent patent claims. Exemplary further developments constitute the subject-matter of the dependent claims.

According to at least one embodiment, the picture recording arrangement comprises at least one image-taking device having an image-taking field of view. For example, the at least one image-taking device is a CMOS image sensor or a CCD sensor. There can be a plurality of the image-taking devices, for example, to enable stereo recording, or there are image-taking devices having different optics. By means of the at least one image-taking device, taking pictures and/or videos may be enabled.

According to at least one embodiment, the picture recording arrangement comprises a light source. The light source includes a plurality of light-emitting units, for example, N light-emitting units wherein N is a natural number. For example, 6≤N≤30. The light source can be a single component, that is, one individual device, or the light source is alternatively composed of a couple of components. Hence, all the light-emitting units may be integrated in the single component, or each one or groups of the light-emitting units are configured as individual components. The light-emitting units may be multi-color units, that is, may be configured to independently emit red, green and blue light and, thus, may be RGB units. Otherwise, the light-emitting units may each have only one color channel, for example, to emit specific white light. It is possible that different kinds of light-emitting units, for example, with different spatial and/or spectral emission characteristics, are combined within the light source. For example, the light-emitting units are composed of light-emitting diodes, LEDS for short.

According to at least one embodiment, the light-emitting units are configured to emit light along a plurality of emission directions. It is possible that there is a one-to-one assignment between the light-emitting units and the emission directions. Otherwise, one or some or all the emission directions may be provided with a plurality of the light-emitting units. That is, the number N of the light-emitting units can be larger than a number M of the emission directions wherein M is a natural number, too.

The light source may thus be configured to emit visible light, like white light or red, green and/or blue light in any combination. It is optionally possible that the light source may emit infrared radiation, for example, near-infrared radiation referring to the spectral range from 750 nm to 1.2 μm. That is, along each emission direction visible light and/or infrared radiation can be emitted. For example, there are M emission directions wherein M is a natural number. For example, 2≤M≤40 or 6≤M≤30 or 10≤M≤20.

According to at least one embodiment, the emission directions point outside the image-taking field of view. For example, the optical axes of the light-emitting units point outside the image-taking field of view. Alternatively or additionally, at most 20% or at most 10% or at most 5% or at most 1% of a luminous flux emitted by the light-emitting units and measured in lumen may be emitted in the image-taking field of view. This may apply for each one of the light-emitting units or collectively for all the light-emitting units.

According to at least one embodiment, the picture recording arrangement comprises a depth sensor. The depth sensor comprises a plurality of depth sensor units, for example, K depth sensor units wherein K is a natural number. The depth sensor units are configured to determine at least one distance along a plurality of sensor directions between the picture recording arrangement and at least one reflective surface. For example, the depth sensor units and the sensor directions are assigned in a one-to-one manner so that there are K sensor directions as well as K depth sensor units. Otherwise, there can be more depth sensor units than sensor directions.

For example, along each one of the sensor directions a distance between the picture recording arrangement and a surface is determined, up to a maximum distance that can be measured which is, for example, at least 5 m or at least m. Hence, along each one of the sensor directions it is measured if there is a reflective surface along the respective sensor direction.

According to at least one embodiment, the sensor directions point outside the image-taking field of view. Thus, the at least one reflective surface is located outside the image-taking field of view. Hence, by illuminating the determined at least one reflective surface with the corresponding at least one light-emitting unit a target within the image-taking field of view can be illuminated in an indirect manner, that is, with bouncing light.

In at least one embodiment, the picture recording arrangement comprises:
an image-taking device having an image-taking field of view,
a light source comprising a plurality of light-emitting units configured to emit light along a plurality of emission directions, the emission directions point outside the image-taking field of view, and
a depth sensor comprising a plurality of depth sensor units configured to determine at least one distance along a plurality of sensor directions between the picture recording arrangement and at least one reflective surface, the sensor directions point outside the image-taking field of view.

By means of the picture recording arrangement, a method to control a group of light-emitting units to match a target light distribution while illuminating a scene, based on environment analysis, is enabled. For example, the light source is a multi-LED flash used in photo applications in low-light configuration in various environments to detect the influence of the environment on the LED illumination.

The picture recording arrangement described herein intends to solve the problem of providing better artificial lighting when taking pictures in a low-light environment from a mobile phone, for example. Cameras in mobile phones are typically very small, so that they cannot receive a big amount of light and therefore behave poorly in low-light environment, producing images with a lot of noise. To get a good image exposition, one possibility is to try to add artificial lighting to the scene, by turning on some artificial light sources during image capture. The nature of this additional light can have a huge impact on the quality of the final picture, and the picture recording arrangement described herein proposes a solution to improve the way flash LEDs can bring light into a low-light scene. The picture recording arrangement described herein focusses on improving the quality of artificial flash particularly for indoor environments.

Some approaches to capture of information about the environment of the target to be pictured are, for example:
to estimate a three-dimensional, 3D, representation of the scene in the field of view of the camera with a 3D sensor or by estimating the 3D environment from a monocular image;
to estimate a 3D representation of the scene including areas outside of the field of view of the camera via the camera of the phone and/or a 3D sensor of the phone while the user moves the phone in front of the subject, wherein the 3D sensor points into the field of view. This approach may be used in augmented reality, AR, applications;
to estimate the spatial distribution of light in the scene, like intensity and color, using a segment ambient light sensor pointing to the scene.

In mobile phone based AR applications, artificial content may be superimposed on the video that is captured in real-time via the phone camera. In order to anchor this artificial content to the real scene, the AR application has to perform an analysis of the scene to determine the pose of the camera and map the screen two-dimensional, 2D, coordinates to the real world 3D coordinates. Several solutions may be used for that. For example, Simultaneous Localization And Mapping, SLAM, may be used. SLAM allows to build a 3D representation of the environment as the phone camera is moved.

Stereo cameras, Light imaging, detection and ranging, LIDARs for short, and 3D time-of-flight sensors, 3D ToF for short, are three examples of 3D sensors. Mobile phones can be fitted with such a 3D sensor pointing in the same direction as the camera and having a field of view close to the one of the camera. At a given phone pose, capturing the 3D information with such a sensor allows to get a 3D map of the scene in the field of view of the camera.

By scanning the phone, the field of view of the 3D sensor can in principle be broaden to get a wider representation of the environment in 3D. Given the setup of the adaptive flash where the LED array is illuminating outside of the field of view of the camera, capturing the 3D scene in the field of view of the camera does not give any information on the surfaces where the light from the flash is to bound. To get this information, a user would need to scan the phone in order to capture information that is outside of the field of view of the camera. This is cumbersome and not easy to control.

In the picture recording arrangement described herein, a special multi-zone depth sensor is used. This sensor has several individual depth sensor units each of them pointing to a specific direction. The depth sensor can be based on depth sensing technologies like ToF, LIDAR or a self-mixing interferometer, SMI for short.

The individual depth sensor units may point in the same direction as the light-emitting units of the adaptive flash device; in this case, the number of depth sensors is equal to the number of light-emitting units of the adaptive flash, or the number of emission directions is equal to the number of sensor directions. As an alternative, the number of individual depth sensor units is lower than the number of light-emitting units in the adaptive flash so that the number of emission directions may be higher than the number of sensor directions.

In both cases, the depth sensor units allow to estimate the distance to a surface when each light-emitting unit of the flash will bounce. From this information, it is possible to select which light-emitting units will be used to illuminate the scene. Namely, for example, the light-emitting units are selected that point to the closest bouncing surface to shine light on the scene. It is alternatively or additionally also possible to determine the intensity of the illumination to use; for example, the larger the distance, the higher the intensity to be used. When there are less depth sensor units and/or sensor directions than light-emitting units and/or emission directions, an interpolation may be performed.

For example, the depth sensor is organized in as three sensor triplets comprising thus a total of nine depth sensor units. Each triplet pointing to one of the ‘top”, “left” and “right” directions, relative to the image-taking device. The three sensors in each triplet can slightly point in a different direction so as to determine three depth points in the ‘top”, “left” and “right” directions. Each of the triplets thereby allows to estimate the distance and orientation of a bouncing surface—this assumes, for example that the surfaces are planar.

Based on the estimation of the bouncing surfaces, it is possible to select which light-emitting units are to be used to optimize the bouncing of light onto the scene.

Some advantages of the solution presented herein may be as follows:
Fast operation is enabled as the environment can be analyzed in a fraction of a second.
Ease of operation is enabled as the user does not need to scan the environment.
Optimal estimation of the bouncing surfaces is possible whereby optimizing the illumination and saving power by only illuminating the light-emitting units that contribute to the illumination of the scene.

According to at least one embodiment, the image-taking device is configured to take a picture of a target located within the image-taking field of view. For example, the target comprises at least one object and/or at least one person.

According to at least one embodiment, the light source is configured to provide indirect illumination of the target by means of illuminating the at least one reflective surface located outside the image-taking field of view. It is possible that exactly one or also a plurality of reflective surfaces is simultaneously used to illuminate the target with bouncing light.

According to at least one embodiment, the depth sensor is configured to interpolate between measurement values along the sensor directions to provide a distance value for each one of the emission directions, even if at least one specific emission direction does not run along one of the sensor directions.

According to at least one embodiment, the depth sensor comprises or consists of three triplets of the depth sensor units. Correspondingly, there can be three triplets of the assigned sensor directions which point to the top, to the left and to the right, respectively, relative to the image-taking device. Other than triplets, alternatively pairs or quadruplets or quintuplets or any combinations thereof may be used.

According to at least one embodiment, the depth sensor is configured to determine relative distances along the sensor directions between the at least one reflective surface and the picture recording arrangement. Thus, it is not necessary to determine absolute values of the distances, for example, measured in meters, but it may be sufficient to derive along which one of the sensor directions there is the most close reflective surface, along which one of the sensor directions there is the second-close reflective surface, and so on, and along which one of the sensor directions there is no reflective surface in range. Otherwise, the distances may be determined with their absolute values, that is, measured in meters. However, relatively large measurement tolerances may apply so that the measured distances may be determined, for example, with a relative accuracy of 10% or better or of 20% or better or of 30% or better.

According to at least one embodiment, the depth sensor is configured to determine which one of the sensor directions corresponds to a reflective surface that is closer to the picture recording arrangement than the target. Thus, for example, one or some or all of the determined reflective surfaces determined to be closer to the picture recording arrangement than the target may be used for indirectly illuminating the target.

According to at least one embodiment, the depth sensor is configured to determine the at least one reflective surface which is located closest to the picture recording arrangement, seen along the sensor directions. For example, the depth sensor determines only the closest reflective surface, and only this reflective surface is used for indirect illumination of the target.

According to at least one embodiment, one or some or all of the depth sensor units are selected from the following group: time-of-flight sensor, LIDAR sensor, stereo sensor or stereo camera, self-mixing interferometer. In particular, the depth sensor units are SMIs.

According to at least one embodiment, one or some or all of the depth sensor units are configured to determine intensities of a radiation emitted along the sensor directions and reflected back to the depth sensor at the at least one reflective surface. Thus, a relative distance between the picture recording arrangement and the reflective surfaces may be determined by means of the fraction of radiation reflected back from the respective reflective surface to the picture recording arrangement. In this case, the depth sensor units may use the light-emitting units as sources for the radiation to be reflected and to be detected afterwards.

According to at least one embodiment, the depth sensor units are configured to emit near-infrared radiation. Alternatively or additionally, the depth sensor units are configured to emit visible light and/or near-ultraviolet radiation. Near-ultraviolet radiation may refer to a wavelength range between 350 nm and 410 nm.

According to at least one embodiment, the light-emitting units are configured to emit visible light, like white light. It is possible that a hue, a color saturation and/or a correlated color temperature, CCT, of the light-emitting units can be adjusted.

According to at least one embodiment, an emission angle between an optical axis of the image-taking device and at least some of the emission directions and/or of the sensor directions is at least 20° or is at least 30°. Alternatively or additionally, said angle is at most 75° or is at most 60° or is at most 50°.

According to at least one embodiment, for one or for some or for all of the emission directions and/or the sensor directions an emission angle width per emission direction and/or per sensor directions is at least 2° or is at least 5° or is at least 10° or is at least 15°. Alternatively or additionally, said angle is at most 55° or is at most 45° or is at most 30°.

It is possible that the emission angles of the emission directions and of the sensor directions are the same. Alternatively, the emission directions on the one hand and the sensor directions on the other hand have different emission angles. For example, the emission angles of the sensor directions are smaller than the emission angles of the emission directions, especially if the depth sensor units are based on laser technology.

According to at least one embodiment, the depth sensor units and the light-emitting units are arranged in a circular manner around the image-taking device, seen in top view of the image-taking device. For example, the depth sensor units and the light-emitting units can be arranged in the same circle around the image-taking device. Otherwise, the depth sensor units may be arranged along an inner circle and the light-emitting units may be arranged along an outer circle around the image-taking device.

Otherwise, it is possible that the light-emitting units and/or the depth sensor units are arranged in at least one matrix. For example, the depth sensor units are arranged in a matrix, and the light-emitting units are arranged in a circular arrangement, possibly around the image-taking device only or around the image-taking device as well as around the depth sensor units.

According to at least one embodiment, the picture recording arrangement is a mobile device. For example, the picture recording arrangement is a smart phone or a tablet computer.

A method for operating the picture recording arrangement is additionally provided. For example, by means of the method a picture recording arrangement as indicated in connection with at least one of the above-stated embodiments is operated. Features of the picture recording arrangement are therefore also disclosed for the method and vice versa.

In at least one embodiment, the method is for adapting illumination and comprises the following steps, for example, in the stated order:
A) Providing picture recording arrangement comprising an image-taking device having an image-taking field of view, a light source comprising a plurality of light-emitting units having emission directions pointing outside the image-taking field of view, and a depth sensor comprising a plurality of depth sensor units,
B) Emitting radiation by the depth sensor units along a plurality of sensor directions and determining at least one distance along the sensor directions between the picture recording arrangement and at least one reflective surface outside the image-taking field of view, the sensor directions point outside the image-taking field of view, and
C) Taking at least one image of a target located in the mage-taking field of view, wherein light is emitted by at least one of the light-emitting units along at least one of the emission directions so that the target is indirectly illuminated by means of illuminating the at least one reflective surface located outside the image-taking field of view.

In this method, for example, a picture recording arrangement is used that contains a set of, for example, M independently controlled light-emitting units, all close to the camera but each pointing in a different direction. A process or an algorithm may be used to optimize the intensity applied to each light-emitting unit during the flash to provide the desired indirect illumination.

A picture recording arrangement and a method described herein are explained in greater detail below by way of exemplary embodiments with reference to the drawings. Elements which are the same in the individual figures are indicated with the same reference numerals. The relationships between the elements are not shown to scale, however, but rather individual elements may be shown exaggeratedly large to assist in understanding.

In the figures:

FIG. 1 is a schematic side view of an exemplary embodiment of a method using a picture recording arrangement described herein,

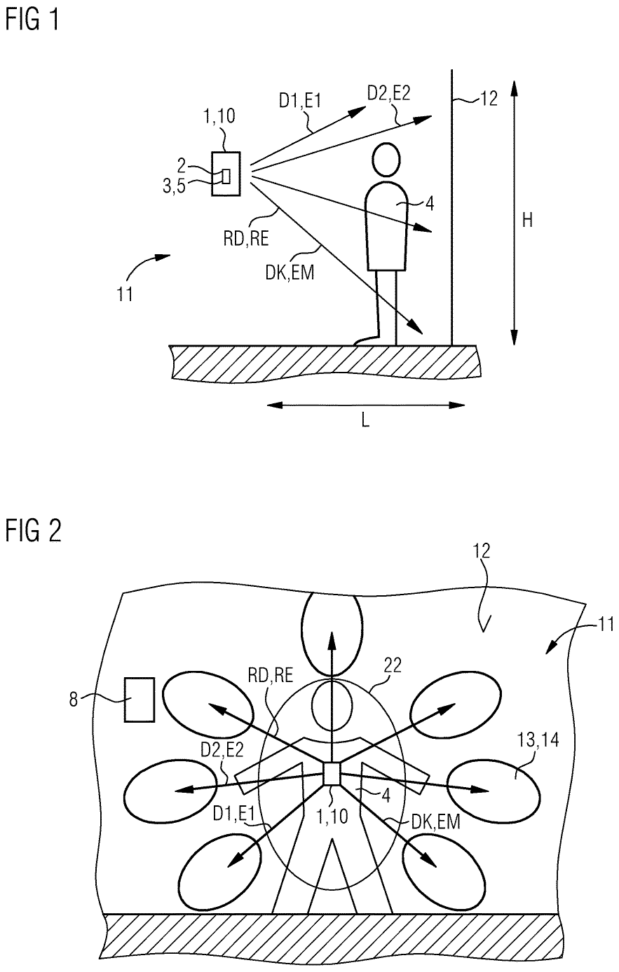

FIG. 2 is a schematic front view of the method of FIG. 1,

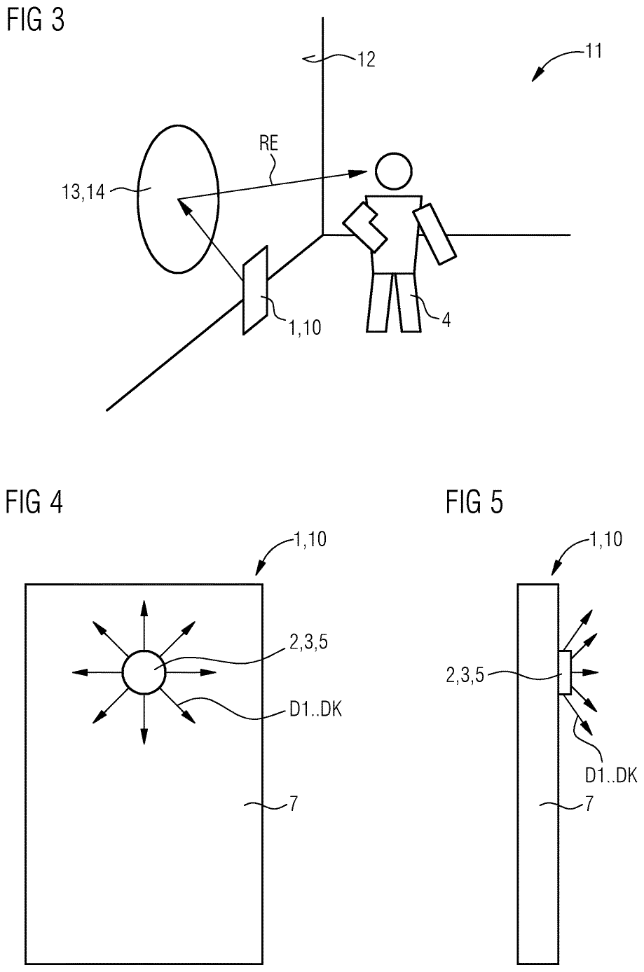

FIG. 3 is a schematic perspective view of an exemplary embodiment of a method using a picture recording arrangement described herein,

FIG. 4 is a schematic top view of an exemplary embodiment of a picture recording arrangement described herein,

FIG. 5 is a schematic side view of the picture recording arrangement of FIG. 4,

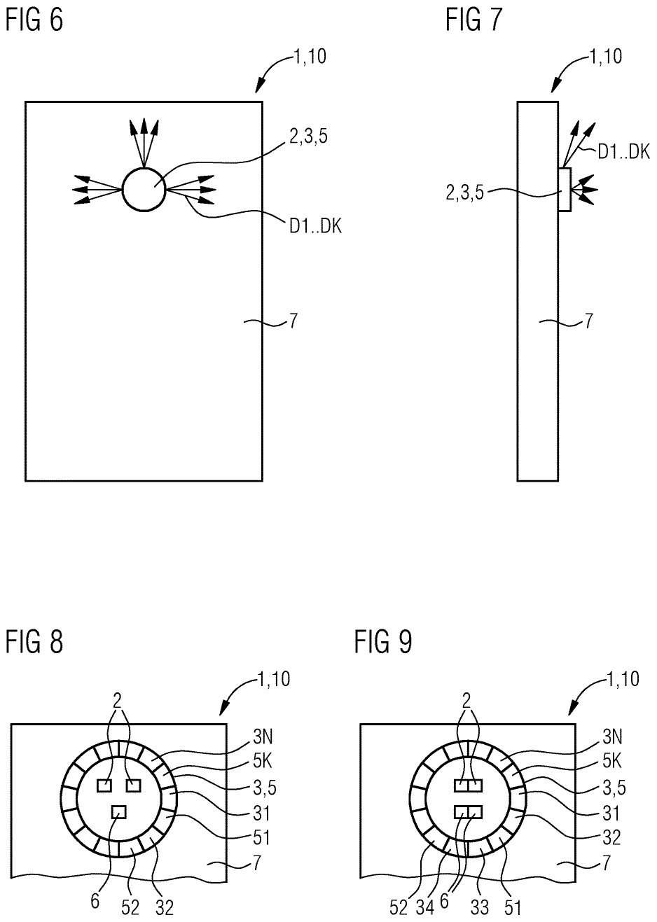

FIG. 6 is a schematic top view of an exemplary embodiment of a picture recording arrangement described herein,

FIG. 7 is a schematic side view of the picture recording arrangement of FIG. 6,

FIGS. 8 to 11 are schematic top views of exemplary embodiments of picture recording arrangements described herein, and

FIG. 12 is a schematic representation of the emission characteristics of a light-emitting unit and of a depth sensor unit for exemplary embodiments of picture recording arrangements described herein.

FIGS. 1 and 2 illustrate an exemplary embodiment of a method using a picture recording arrangement 1. The picture recording arrangement 1 is a mobile device 10 and comprises an image-taking device 2, like a CMOS image sensor or a CCD sensor, configured to take photos and/or videos. Further, the picture recording arrangement 1 comprises a light source 3 and a depth sensor 5. A user of the picture recording arrangement 1 is not shown in FIGS. 1 and 2.

In the intended use, the picture recording arrangement 1 is used indoors to take, for example, an image of a target 4 in a scene 11. For example, the target 4 is a person to be photographed. For example, a distance L between the target 4 and the picture recording arrangement 1 is a least 0.5 m and/or is at most 5 m. It is possible that a size H of the target 4 is at least 0.2 m and/or is at most 2 m. The target 4 can be located in front of a wall 12 or any other item, for example, in front of the target 4 that provides a bouncing surface on the sides of the target 4 so that indirect lighting can be provided. The target 4 can be directly at the wall or can have some distance to the wall 12.

The light source 3 is configured to emit an image-taking radiation RE, like visible light, along a plurality of emission directions E1 . . EM. Thus, there are M emission directions. For example, M is between ten and 20 inclusive. By means of the light source 3, for example, for each one of the emission directions E1 . . EM one illuminated area 13 is present next to the target 4 out of a field-of-view of the image-taking device 2. Thus, the light source 3 provides indirect lighting. The emission of radiation RE along the emission directions E1 . . EM can be adjusted by means of a processing unit of the picture recording arrangement 1, for example.

In order to determine suitable illuminated areas 13, there is the depth sensor 5 comprising K depth sensor units 51 . . 5K to determine a distance between the respective illuminated areas 13 and the mobile device 10 along sensor directions D1 . . DK. For example, for each sensor direction D1 . . DK there is one of the depth sensor units 51 . . 5K. The depth sensor units 51 . . 5K are, for example, SMIs. Concerning SMIs, reference is made to document WO 2022/212607 A1, the disclosure content of which is hereby incorporated by reference.

According to FIGS. 1 and 2, K=M, but it is also possible that K≠M, especially that K<M.

By having the depth sensor 5 with the sensor directions D1 . . DK pointing outside the field-of-view 22 of the image-taking device 2, for example, only such reflective surfaces 14 may be chosen which are located in front of the target 4 so that reflective surfaces behind the target 4, from the perspective of the mobile device 10, may not be illuminated in order to avoid a glaring effect.

In another application scenario of the method, for example, in a room the picture recording arrangement 1 and the target 4 are located there is also a luminaire 8 that provides weak lighting. A mood provided by the luminaire 8 may be reproduced by the picture recording arrangement 1. In order to do so and realizing a high picture quality, the light source 3 addresses, for example, in particular the illumination areas 13 being about in the same orientation relative to the target 4 as the luminaire 8. In FIG. 2, this would be, for example, the illumination areas 13 in the upper left area next to the luminaire 8. In this example, the mood can be kept while good illumination conditions can be present when taking the picture by having the light source 3 as an adapted photo flash. The selection of suitable illumination areas 13 and, thus, the adaption of the light source 3 to the desired mood, can be highly improved by using the depth sensor 5.

Adaption can also be to a pre-selected mood derived, for example, from a template or another picture or video, and by means of the depth sensor 5 adaption can be simplified because the most suitable illumination areas 13 to achieve said mood can effectively be selected.

In FIG. 3, another example is illustrated. In this example, the target 4 is a person standing near a corner of a room. By using the depth sensor 5, it is determined that the nearest reflective surface 14 and, thus, the most suitable illumination area 13 is located on a left side of the mobile device 10, that is, on a right side of the person 4. Hence, after determining the illumination area 13 by means of the depth sensor 5, the light source 3 can illuminate said illumination area 13 in a targeted manner to provide indirect illumination on the person 4.

Otherwise, the same as to FIGS. 1 and 2 may also apply to FIG. 3, and vice versa.

In FIGS. 4 and 5, an example of the picture recording arrangement 1 is provided. The picture recording arrangement 1 may be a smart phone 10. The depth sensor 5 may be integrated in a combined camera and flash 2, 3. The depth sensor units 51 . . 5K of the depth sensor 5 are configured to determine a distance towards a next surface along the K sensor directions D1 . . DK. For example, seen in top view of the combined camera and flash 2, 3, the sensor directions D1 . . DK are distributed in a rotation symmetric and/or equidistant manner so that between adjacent sensor directions D1 . . DK there is a same angle. All the sensor directions D1 . . DK point away from the combined camera and flash 2, 3 so that the combined camera and flash 2, 3 point out of a field-of-view of the image-taking device 2, that is, of the camera 2.

The number K of the sensor directions D1 . . DK may be the same as the number M of emission directions E1 . . EM, or K is smaller than M. The latter is preferred.

Otherwise, the same as to FIGS. 1 to 3 may also apply to FIGS. 4 and 5, and vice versa.

In the example of the picture recording arrangement 1 as shown in FIGS. 6 and 7, the picture recording arrangement 1 again may be a smart phone 10. There are nine of the sensor directions D1 . . DK arranged in three triplets. The sensor directions D1 . . D3 of one of the triplets points to the left, another three sensor directions D4 . . D6 point to the right, and the remaining three sensor directions D7 . . D9 point to the top, seen relative from the image-taking device 2, which is, for example, the combined camera and flash 2, 3.

Within each triplet, the sensor directions D1 . . D9 run along slightly different directions. Optionally, within each triplets the sensor directions D1 . . D3, D4 . . D6 and D7 . . D9 may each be located in a common plane. For example, an angle between the sensor directions D1 . . D3, D4 . . D6 and D7 . . D9 within one of the triplets is at least 10° or at least 15° and/or is at most 30° or is at most 20°.

Thus, indirect lighting from a left side, a top side and/or a right side of the target 4 is enabled.

Otherwise, the same as to FIGS. 4 and 5 may also apply to FIGS. 6 and 7, and vice versa.

In FIGS. 8 to 11, some exemplary embodiments of the picture recording arrangement 1 are shown. In all these examples, the picture recording arrangement 1 is a mobile device 10, like a smartphone or a tablet computer. However, the aspects described below may also apply analogously to other kinds of picture recording arrangements 1.

The light source 3 comprises the plurality of the light-emitting units 31 . . 3M. The light-emitting units 31 . . 3M can be light-emitting diodes, LEDs for short. It is possible that the light-emitting units 31 . . 3M are arranged in a circular manner, that is, on a circle or on an ellipse or on a regular polygon, seen in top view of the image-taking device 2.

However, other arrangements of the light-emitting units 31 . . 3M around the image-taking device 2 are likewise possible. This is because a distance between the light-emitting units 31 . . 3M is very small compared with a distance between the illuminated areas 13, compare FIG. 2, so that it is not necessary that an arrangement order of the light-emitting units 31 . . 3M corresponds to an arrangement order of the illuminated areas 13. Hence, it is alternatively also possible for the light-emitting units 31 . . 3M to be arranged in a matrix, for example. The same is possible for the sensor directions D1 . . DK, too.

If the light-emitting units 31 . . 3M are arranged on a circle or on an ellipse or on a regular polygon, it is possible that the respective emission directions E1 . . EM associated with the light-emitting units 31 . . 3M can point inwards, that is, can cross a center of the circle or ellipse or polygon. The same is possible for the sensor directions D1 . . DK, too.

Moreover, the picture recording arrangement 1 includes the at least one image-taking device 2. Optionally, the picture recording arrangement 1 can include at least one additional light-emitting unit 6. The at least one additional light-emitting unit 6 can also be configured as a photo flash. In particular, the at least one additional light-emitting unit 6 may be configured for direct illumination of the target 4 so that an optical axis of the at least one additional light-emitting unit 6 can point into the field-of-view 22 of the image-taking device 2.

All the components 2, 3, 5, 6 of the picture recording arrangement 1 can be integrated into a housing 7.

According to FIG. 8, there are two of the image-taking devices 2, for example, for different field-of-views 22 or for stereo pictures or videos. Further, there are K sensor directions D1 . . DK and M emission directions E1 . . EM wherein K=M. The N light-emitting units 31 . . 3N and the K depth sensor units 51 . . 5K may be arranged in an alternating manner on the same circle or ellipse or regular polygon so that N=K may apply. Both the at least one image-taking device 2 and the optional at least one additional light-emitting unit 6 are arranged within said circle or ellipse or polygon, for example, in a center area of said circle or ellipse or polygon.

Otherwise, the same as to FIGS. 1 to 7 may also apply to FIG. 8, and vice versa.

In FIG. 9 it is illustrated that K<N wherein A×K=N may apply, for example, wherein A is a natural number. For example, 2≤A≤10 or 2≤A≤4. According to FIG. 9, A=2. Further, in FIG. 9 it is shown that there is a plurality of the additional light-emitting units 6.

Otherwise, the same as to FIG. 8 may also apply to FIG. 9, and vice versa.

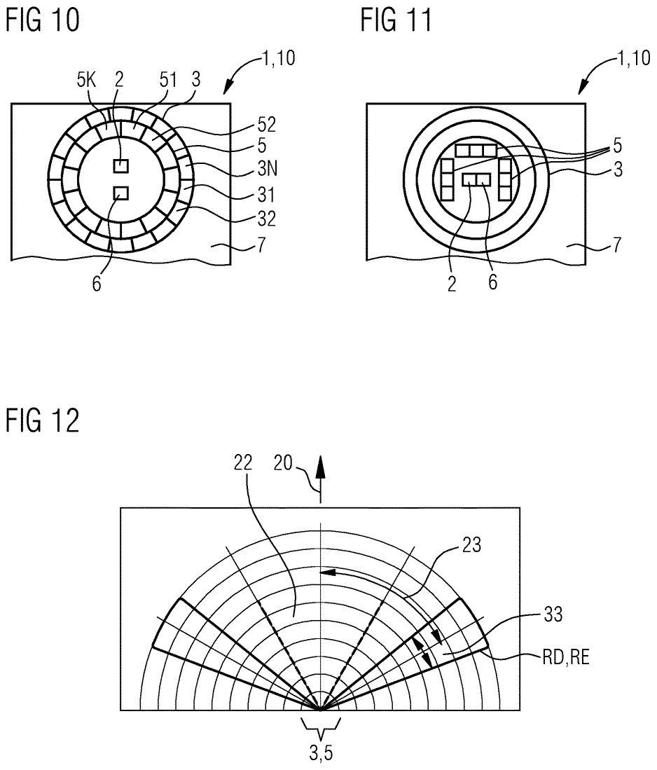

According to FIG. 10, the light-emitting units 31 . . 3N are arranged on an outer circle or ellipse or regular polygon whereas the depth sensor units 51 . . 5K are arranged on an inner circle or ellipse or regular polygon around the at least one image-taking device 2 and optionally around the at least one additional light-emitting unit 6, if the latter is present. Hence, it is possible that K<N.

The inner and the outer circles or ellipses or polygons may be arranged directly next to one another or, other than shown in FIG. 10, there may be a distance between the inner and the outer circles or ellipses or polygons.

Otherwise, the same as to FIGS. 8 and 9 may also apply to FIG. 10, and vice versa.

In FIG. 11 it is illustrated that the light-emitting units 31 . . 3N are again arranged on a circle or ellipse or regular polygon. However, the depth sensor units 51 . . 5K may be arranged in at least one matrix or row, for example, within the circle or ellipse or regular polygon.

According to FIG. 11, there are three rows of the depth sensor units 51 . . 5K, one on the left, one on the top and one on the right of the image-taking device 2. With such an arrangement of the depth sensor units 51 . . 5K, the triples of FIGS. 6 and 7 may be implemented.

As an option, the image-taking device 2 and the additional light-emitting unit 6, if present, are integrated in a single component. The same may be true in all other embodiments, too.

Otherwise, the same as to FIGS. 8 to 10 may also apply to FIG. 11, and vice versa.

In FIG. 12, exemplary parameters of the emission directions E1 . . EM and/or of the sensor directions D1 . . DK are illustrated. For example, an angle 23 between an optical axis of the image-taking device 2 and the emission directions E1 . . EM and/or of the sensor directions D1 . . DK is about 60°. An emission angle width 33 of the emission directions E1 . . EM and/or of the sensor directions D1 . . DK may be about 30° in each case, however, the emission angle width 33 of the emission directions E1 . . EM may differ from that of the sensor directions D1 . . DK. Thus, no or virtually no radiation RE and/or RD is emitted into the field-of-view 23 of the image-taking device 2.

The components shown in the figures follow, unless indicated otherwise, exemplarily in the specified sequence directly one on top of the other. Components which are not in contact in the figures are exemplarily spaced apart from one another. If lines are drawn parallel to one another, the corresponding surfaces may be oriented in parallel with one another. Likewise, unless indicated otherwise, the positions of the drawn components relative to one another are correctly reproduced in the figures.

The invention described here is not restricted by the description on the basis of the exemplary embodiments. Rather, the invention encompasses any new feature and also any combination of features, which includes in particular any combination of features in the patent claims, even if this feature or this combination itself is not explicitly specified in the patent claims or exemplary embodiments.

This patent application claims the priority of German patent application 10 2023 112 280.0, the disclosure content of which is hereby incorporated by reference.

### LIST OF REFERENCE SIGNS

1 picture recording arrangement
10 mobile device
11 scene
12 wall
13 illuminated area
14 reflective surface
2 image-taking device
20 optical axis
22 field-of-view
23 emission angle
3 light source
3 . . light-emitting unit
33 emission angle width
4 target
5 depth sensor
5 . . depth sensor unit
6 additional light-emitting unit
7 housing
8 luminaire
D . . sensor direction
E . . emission direction
H size
L distance
RD distance-measuring radiation
RE image-taking radiation

1. A picture recording arrangement (1) comprising:
an image-taking device having an image-taking field of view;
a light source comprising a plurality of light-emitting units configured to emit light along a plurality of emission directions, wherein the emission directions point outside the image-taking field of view; and
a depth sensor comprising a plurality of depth sensor units configured to determine at least one distance along a plurality of sensor directions between the picture recording arrangement and at least one reflective surface, wherein the sensor directions point outside the image-taking field of view,
wherein the emission directions and the sensor directions are assigned to one another in a one-to-one manner.

2. The picture recording arrangement according to claim 1, wherein the image-taking device is configured to take a picture of a target located within the image-taking field of view, and the light source is configured to provide indirect illumination of the target by illuminating the at least one reflective surface located outside the image-taking field of view.

3. The picture recording arrangement according to claim 1, wherein the depth sensor comprises three triplets of the depth sensor units, wherein the sensor directions assigned to the three triplets point to the top, to the left and to the right, respectively, relative to the image-taking device.

4. The picture recording arrangement according to claim 1, wherein the depth sensor is configured to determine relative distances along the sensor directions between the at least one reflective surface and the picture recording arrangement.

5. The picture recording arrangement according to claim 1, wherein the depth sensor is configured to determine the at least one reflective surface which is located closest to the picture recording arrangement, seen along the sensor directions.

6. The picture recording arrangement according to claim 1, wherein at least some of the depth sensor units are selected from the following group: time-of-flight sensor, LIDAR sensor, stereo camera, self-mixing interferometer.

7. The picture recording arrangement according to claim 1, wherein at least some of the depth sensor units are configured to determine intensities of a radiation emitted along the sensor directions and reflected back to the depth sensor at the at least one reflective surface.

8. The picture recording arrangement according to claim 1, wherein the depth sensor units are configured to emit near-infrared radiation, and the light-emitting units are configured to emit visible light.

9. The picture recording arrangement according to claim 1, wherein an emission angle between an optical axis of the image-taking device and at least some of the emission directions and/or of the sensor directions is between 30° and 75° inclusive.

10. The picture recording arrangement according to claim 1, wherein there are at least six and at most 30 of the emission directions.

11. The picture recording arrangement according to claim 1, wherein the depth sensor units and the light-emitting units are arranged in a circular manner around the image-taking device, seen in top view of the image-taking device.

12. The picture recording arrangement according to claim 1, wherein the picture recording arrangement is a mobile device.

13. The picture recording arrangement according to claim 12, wherein the picture recording arrangement is a smart phone.

14. The picture recording arrangement according to claim 1, wherein the light source is configured as a photo flash.

15. A method for adapting illumination comprising:
providing picture recording arrangement comprising an image-taking device having an image-taking field of view, a light source comprising a plurality of light-emitting units having emission directions pointing outside the image-taking field of view, and a depth sensor comprising a plurality of depth sensor units,
emitting radiation by the depth sensor units along a plurality of sensor directions and determining at least one distance along the sensor directions between the picture recording arrangement and at least one reflective surface outside the image-taking field of view, wherein the sensor directions point outside the image-taking field of view, and
taking at least one image of a target located in the image-taking field of view, wherein light is emitted by at least one of the light-emitting units along at least one of the emission directions so that the target is indirectly illuminated by illuminating the at least one reflective surface located outside the image-taking field of view.

16. The picture recording arrangement according to claim 9, wherein for at least some of the emission directions and/or for at least some of the sensor directions an emission angle width per emission direction and/or per sensor directions is between 5° and 45° inclusive.
